(19) United States
(12) Patent Application Publication
(10) Pub. No.: US 2026/0154954 A1
(43) Pub. Date: Jun. 4, 2026

(54) APPARATUS AND METHOD WITH MULTI-MODAL FOUNDATION MODEL

(71) Applicant: Samsung Electronics Co., Ltd., Suwon-si (KR)

(72) Inventors: Minki JEONG, Suwon-si (KR); Seungin PARK, Suwon-si (KR); Hyunjeong LEE, Suwon-si (KR); Sangil JUNG, Suwon-si (KR)

(73) Assignee: Samsung Electronics Co., Ltd., Suwon-si (KR)

(21) Appl. No.: 19/204,735

(22) Filed: May 12, 2025

(30) Foreign Application Priority Data
Nov. 29, 2024 (KR) 10-2024-0175393

(51) Int. Cl. G06V 10/82; G06F 40/284; G06F 40/40; G06V 10/74; G06V 10/77; G06V 10/774

(52) U.S. Cl. CPC G06V 10/82; G06F 40/284; G06F 40/40; G06V 10/761; G06V 10/7715; G06V 10/774

(57) ABSTRACT

Disclosed are a data processing apparatus and method for a multi-modal foundation model (MMFM). The data processing apparatus includes a memory and a processor configured to execute instructions stored in the memory, wherein, when the instructions are executed by the processor, the processor is configured to receive input data including input image data and prompt input data to perform a task, obtain image feature data from the input image data using an image encoder, obtain image token data corresponding to the image feature data using an image tokenizer, and obtain output data corresponding to the input data using an MMFM having the prompt input data, the image feature data, and the image token data as an input.

### CROSS-REFERENCE TO RELATED APPLICATIONS

This application claims the benefit under 35 USC § 119(a) of Korean Patent Application No. 10-2024-0175393, filed on Nov. 29, 2024, in the Korean Intellectual Property Office, the entire disclosure of which is incorporated by reference herein for all purposes.

### BACKGROUND

### 1. Field

The following description relates to a data processing apparatus and method with a multi-modal foundation model (MMFM).

### 2. Description of Related Art

A multi-modal foundation model (MMFM) may receive input from various modalities. A modality may be one type of input data, for example an image data type or a text data type. Unlike an artificial intelligence model to which only a single type of data is input, an MMFM may be trained using data in which modalities are fused together. An MMFM trained using fused data may be used in cases in which there are various types of input data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a data processing apparatus includes: one or more processors; and a memory storing instructions configured to cause the one or more processors to: receive input data including input image data and prompt input data to perform a task; obtain image feature data from the input image data using an image encoder; obtain image token data corresponding to the image feature data using an image tokenizer; and input together or separately(e.g. sequentially), as input data, to a multi-modal foundation model (MMFM), the prompt input data, the image feature data, and the image token data, wherein the MMFM infers output data therefrom.

The instructions may be further configured to cause the one or more processors to control the image tokenizer to determine, as the image token data, a code word corresponding to the image feature data among predefined code words included in a codebook.

The code book may include associations between the predefined code words and predefined pieces of image feature data.

The instructions may be further configured to cause the one or more processors to select the code word by finding one of the pieces of image feature data in the code book that is determined to be similar to the image feature data.

The instructions may be further configured to chase the one or more processors to generate input sequence data to be input to the MMFM using the image feature data, the image token data, and the prompt input data.

The instructions may be further configured to cause the one or more processors to infer the output data by inputting, to the MMFM, data in which the image feature data is concatenated with the image token data, which corresponds to the image feature data.

The image feature data may be a sequence of image features, and the sequence of image features includes a starting index indicating a start of the sequence of image features and an ending index indicating an end of the sequence of image features.

The MMFM may be a multi-modal large language model (MMLLM).

The prompt input data may include text data or text token data obtained from of audio input data or text input data.

In another general aspect, a training apparatus for training a multi-modal foundation model (MMFM) includes: one or more processors; and a memory storing instructions configured to cause the one or more processors to: receive training input data including training input image data and training prompt input data to perform a task; obtain training image feature data from the training input image data using an image encoder; obtain training image token data corresponding to the training image feature data using an image tokenizer; and train the MMFM using the training prompt input data, the training image feature data, and the training image token data.

The instructions may be further configured to cause the one or more processors to: obtain, from the MMFM, output image token data, output image feature data, and output text token data; and train the MMFM using the prompt input data, the training image feature data, the training image token data, the output image token data, and the output text token.

In another general aspect, a data processing method includes: receiving input data including input image data and prompt input data to perform a task; obtaining image feature data from the input image data using an image encoder; obtaining image token data corresponding to the image feature data using an image tokenizer; and inputting together or separately(e.g. sequentially), as input data, to a multi-modal foundation model (MMFM), the prompt input data, the image feature data, and the image token data, wherein the MMFM infers an output therefrom.

The obtaining of the image token data may include controlling the image tokenizer to determine, as the image token data, a code word corresponding to the image feature data among predefined code words included in a codebook.

The data processing method may further include: generating input sequence data to be input to the MMFM using the image feature data, the image token data, and the prompt input data.

The inferring of the output data may include obtaining the output data by inputting, to the MMFM, data in which the image feature data is concatenated with the image token data corresponding to the image feature data.

The image feature data may be a sequence of image features, and the sequence of image features includes a starting index indicating a start of the sequence of image features and an ending index indicating an end of the sequence of image features.

The MMFM may be a multi-modal large language model (MMLLM).

The prompt input data may include text data or text token data obtained from audio input data or text input data.

Other features and aspects will be apparent from the following detailed description, the drawings, and the claims.

### BRIEF DESCRIPTION OF THE DRAWINGS

FIG. 1 illustrates an example of a data processing method, according to one or more embodiments.

FIG. 2 illustrates an example of obtaining output data using a multi-modal foundation model (MMFM) having image feature data and image token data as an input, according to one or more embodiments.

FIG. 3 illustrates an example of obtaining image feature data and image token data, according to one or more embodiments.

FIG. 4 illustrates an example of obtaining output data using an MMFM having concatenated data as an input, according to one or more embodiments.

FIG. 5 illustrates an example of obtaining output data using an MMFM having at least sequence data as an input, according to one or more embodiments.

FIG. 6 illustrates an example of components of a data processing apparatus, according to one or more embodiments.

FIG. 7 illustrates an example of operations of a training method, according to one or more embodiments.

FIG. 8 illustrates an example of training an MMFM based on masked output image feature data, according to one or more embodiments.

FIG. 9 illustrates an example of components of a training apparatus, according to one or more embodiments.

Throughout the drawings and the detailed description, unless otherwise described or provided, it may be understood that the same or like drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

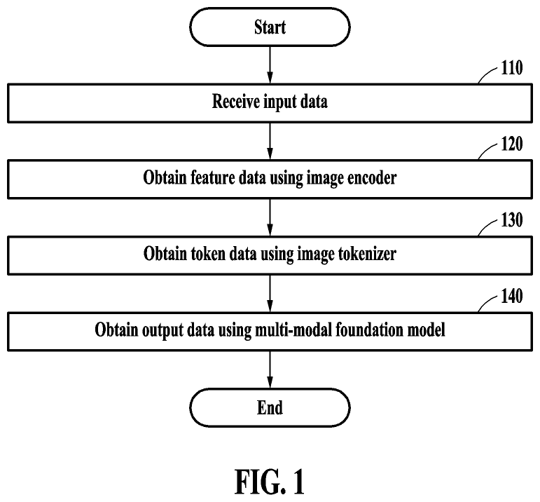

FIG. 1 illustrates an example of a data processing method, according to one or more embodiments.

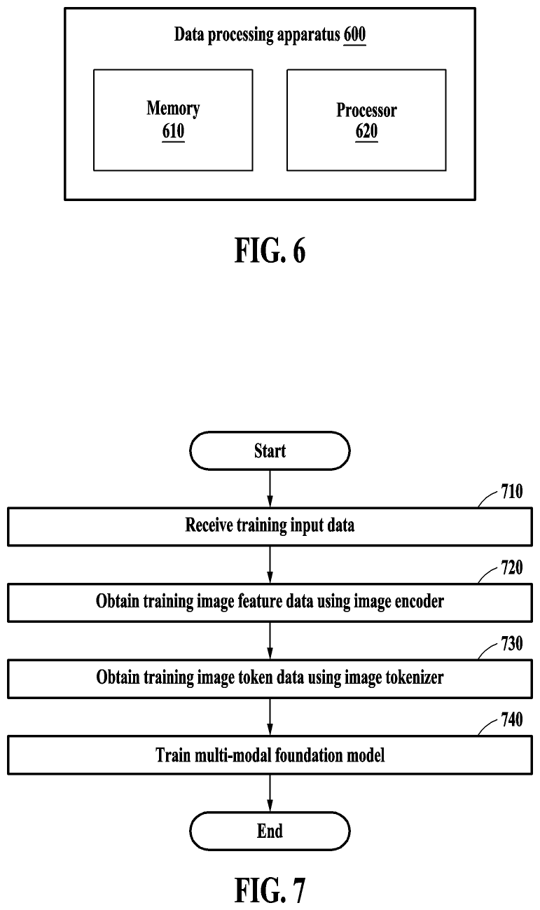

Operations of the data processing method may be performed by a data processing apparatus (e.g., a data processing apparatus 600 of FIG. 6) of the present disclosure. The data processing apparatus may obtain, using a multi-modal foundation model (MMFM), output data corresponding to input data. The MMFM may have inputs of different forms of data (e.g., image data and text data), and, in the case of text data, the text data may include a query input such as a user demand and/or inquiry. The MMFM may infer an output corresponding to a query input. The data processing apparatus may be used in a response system, a recognition system, medical diagnosis, an autonomous driving device, and the like.

Discrete image token data may be obtained by quantizing continuous image feature data. Using only an image token obtained through quantization may increase the robustness of the MMFM but may lose details of input image data. When the details of the image data are lost, there is a concern that important local information of the image, such as object detection, character recognition, or document understanding, may not be reflected in the output data. The data processing apparatus described herein may input to the MMFM image feature data together with discrete image token data obtained through quantization, thereby reducing information loss due to image tokenization and improving the performance of the MMFM. The improved performance of the MMFM may allow more accurate output data to be provided in response to a query input.

Referring to FIG. 1, in operation 110, the data processing apparatus may receive input data. For example, the input data may include input image data and prompt input data for prompting performance of a task. The data processing apparatus may receive the input data through wired communication, wireless communication, or any combination thereof to. The prompt input data functions as an instruction or request signal that causes the MMFM to perform a task, which may be a predetermined task (e.g., display a dialogue from an input image as a script).

The prompt input data may include text data or text token data obtained from audio input data, text input data, or a combination thereof. The text data may be data in the form of characters or words. In the case of text token data, such data may be unit data that is obtained by dividing text data according to a predetermined rule through text tokenization. The text tokenization may include word-level tokenization, character-level tokenization, sentence-level tokenization, or any combination thereof, but examples are not limited thereto. For example, when the audio input data or the text input data is “display a dialogue from an input image as a script”, the obtained prompt input data may be text data “display a dialogue from an input image as a script” or may be text token data (e.g., tokens) “display”, “a dialogue”, “from”, “an input image”, “as a script”.

In operation 120, the data processing apparatus may obtain feature data using an image encoder. The data processing apparatus may obtain image feature data from input image data using the image encoder. The image encoder may extract, from an input image, image feature data (which may be an image feature vector and an image feature map). Obtaining of the image feature data from the input image data using the image encoder is described with reference to FIG. 3.

In operation 130, the data processing apparatus may obtain image token data corresponding to the image feature data, and may do so by applying an image tokenizer to the image feature data. Specifically, the image token data may be data obtained by compressing and quantizing an image feature. That is, the image tokenizer may generate image token data based on quantizing image feature data. The quantizing of the image feature data may include converting (or mapping) the image feature data to a code word by finding the image feature data in a codebook that maps image features to codes/words. More specifically, the codebook may be a dictionary that is obtained during a training process of the MMFM. The codebook may map patterns or features of data into respective code words (or codes) and a code word may be data mapped in the codebook during the training process of the MMFM. In the training process of the MMFM, the codebook may be generated by extracting feature vectors from a training data, selecting representative feature vectors from the extracted feature vectors, and grouping (or assigning) similar feature vectors based on their similarity to the representative feature vector. The codebook may comprise associations between the predefined code words and predefined pieces of image feature data. Associations between the predefined code words and predefined pieces of image feature data may be distance calculated by Euclidean Distance or Cosine Similarity. The determination of image token data using a codebook is described with reference to FIG. 3.

In operation 140, the data processing apparatus may obtain/infer the output data using the MMFM. To do obtain the output data corresponding to the input data, the data processing apparatus may input prompt input data, image feature data, and image token data to the MMFM. The performance of the MMFM may be enhanced by simultaneously performing inference on the image feature data and the image token data. The data processing apparatus may reflect local information in an image (included the input image) to be reflected in the output of the MMFM by simultaneously using the discrete image token data and the continuous image feature data.

The MMFM may be a machine learning model (e.g., a neural network of various possible architectures) that uses multiple modality data (i.e., multi-modal data). The MMFM may include sub-networks. For example, the MMFM include a sub-network such as a convolutional neural network for processing an image and a sub-network such as a recurrent neural network for processing text, and each neural sub-network may include layers for processing input modality data. Multiple modality data may be data that has different types, formats, characteristics, or domains. For example, multiple modality data may include text data, image data, and voice data. The image feature data and the image token data may be concatenated and then inputted to the MMFM.

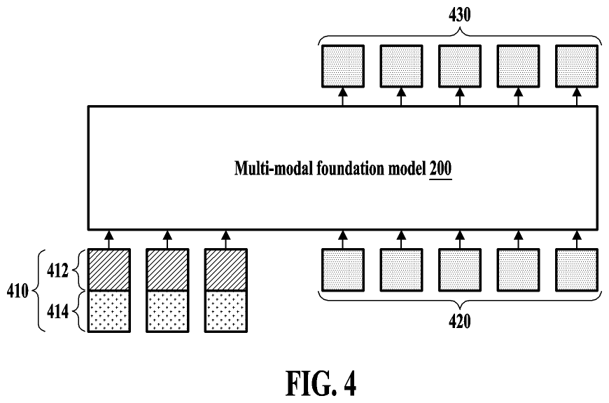

As noted, the data processing apparatus may concatenate the image feature data with the image token data. The concatenated image token data and the image feature data may correspond to each other in the codebook. The data processing apparatus may allow the local information included in the image to be reflected in the output of the MMFM by inputting, to the MMFM, the data in which the image feature data and the image token data are concatenated. The use of data in which the image feature data and the image token data are concatenated by the data processing apparatus is described with reference to FIG. 4.

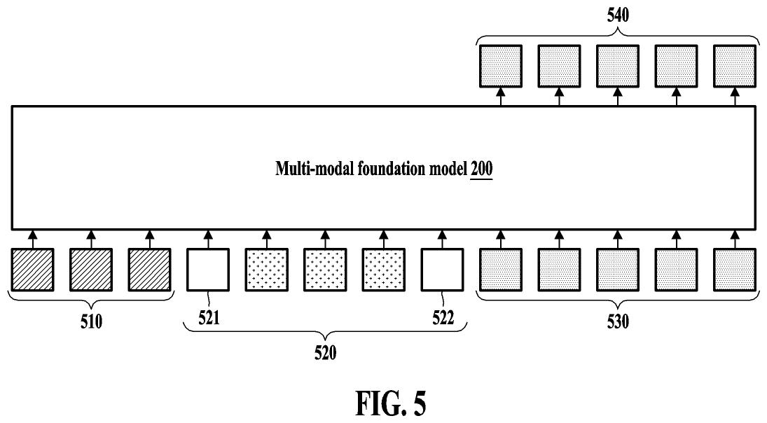

The image feature data may be image feature sequence data having image features arranged in a predetermined order, for example, sequentially. In addition to the image feature data, the image token data or the prompt input data may be sequence data, and examples are not limited thereto. The image feature sequence data may include starting index data indicating the start of the image feature sequence data and ending index data indicating the end of the image feature sequence data. The starting index data may indicate the start of the arranged image feature sequence data, and the ending index data may indicate the end of the arranged image feature sequence data. The use of image feature sequence data including starting index data and ending index data by the data processing apparatus is described with reference to FIG. 5.

The MMFM may be implemented as a multi-modal large language model (MMLLM), which may be an artificial intelligence model that infers a sentence based on multiple modality data as an input. The MMLLM may include a recurrent neural network, a convolutional neural network, an attention-based artificial intelligence model, and various sub-networks. Each sub-network may include an input layer, a hidden layer portion, and an output layer, and the hidden layer portion may include layers with different weights.

The data processing apparatus may generate input sequence data to be input to the MMFM using the image feature data, the image token data, and the prompt input data. The obtaining of the output data using the input sequence data by the data processing apparatus is described with reference to FIG. 5.

The data processing apparatus may allow the MMFM to reflect detailed information of the input image in an output value by simultaneously using the image feature data and the image token data.

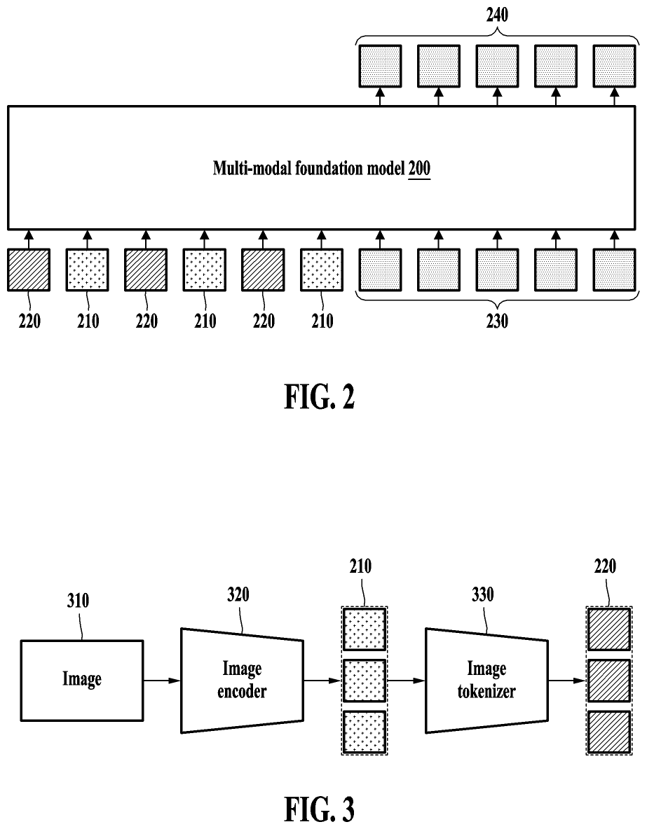

FIG. 2 illustrates an example of obtaining output data using an MMFM having at least image feature data and image token data as an input, according to one or more embodiments.

Referring to FIG. 2, a data processing apparatus may obtain output data 240 corresponding to input data 210-230 using an MMFM 200/the input data 210-230 including prompt input data 230, image feature data 210, and image token data 220.

The prompt input data 230 may include text data or text token data obtained from audio input data (e.g., a voice of a user) or text input data (e.g., text input data of the user), as non-limiting examples.

The output data 240 may be inferred/outputted by the MMFM 200 in response to inputting of the prompt input data 230, the image feature data 210, and the image token data 220. The output data 240 may include output text, an output text token, an output image, an output image token, and/or the like; the type(s) of the output data 240 is not limited thereto. The MMFM 200 may be implemented as an MMLLM, for example.

The MMFM 200 may allow detailed information of the input image data to be reflected in the output value when using the image token data 220, the prompt input data 230, and the image feature data 210 simultaneously, as compared to using only the image token data 220 and the prompt input data 230. The data processing apparatus may use the image token data 220, the prompt input data 230, and the image feature data 210 to improve the accuracy of character recognition (e.g., optical character recognition (OCR)) of the MMFM and to improve the accuracy of object detection in an image. The robustness of the data processing apparatus may be improved by using the image token data 220 including discrete information, and performance of the MMFM may be enhanced by simultaneously using the image token data 220 and the image feature data 210 (which includes continuous/sequence information).

FIG. 3 illustrates an example of obtaining image feature data and image token data by a data processing apparatus, according to one or more embodiments.

Referring to FIG. 3, a data processing apparatus (e.g., the data processing apparatus 600 of FIG. 6) may obtain the image feature data 210 from an image encoder 320 to which an image 310 is inputted.

The image encoder 320 may be/include a convolutional neural network-based encoder, a transformer-based encoder, an autoencoder, or any combination thereof, but examples are not limited thereto. The image encoder 320 may output/infer feature data by preprocessing the input image 310 and extracting a feature from the preprocessed image 310. The preprocessing of the image 310 may include adjusting the size of the input image 310 and normalizing data (e.g., pixel values) of the image 310. The extracting of a feature from the preprocessed image 310 may include performing a convolution using a kernel, followed by a pooling process.

The data processing apparatus may obtain the image token data 220 from an image tokenizer 330 to which the image feature data 210 is inputted. The image tokenizer 330 may output the image token data 220 based on quantizing the image feature data 210. The image tokenizer 300 may quantize the image feature data 210, possibly preceded by compressing the image feature data 210. Quantizing the image feature data 210 may involve mapping the image feature data 210 to data similar to the image feature data 210 in a codebook, and obtaining a code word in the codebook that is associated with the similar data in the codebook. Specifically, the data processing apparatus may control the image tokenizer 300 to map a code word corresponding to the image feature data 210 among predefined code words included in the codebook to the image token data 220 and may thereby obtain the image token data 220 in which the image feature data 210 is quantized. The data processing apparatus may obtain the codebook through training of the MMFM. The image tokenizer 330 may include a vector quantized variational autoencoder (VQ-VAE) tokenizer based on vector quantization, a vision transformer vector quantization (Vit-VQ) tokenizer that quantizes an output feature of a vision transformer, a tokenizer that converts an image into an integer token to generate a text-image pair, or any combination thereof. However, examples are not limited thereto.

FIG. 4 illustrates an example of obtaining output data using an MMFM having concatenated data as an input, according to one or more embodiments.

Referring to FIG. 4, a data processing apparatus (e.g., the data processing apparatus 600 of FIG. 6) may infer output data 430 from concatenated data 410 inputted to the MMFM 200 (described with reference to FIG. 1). The data processing apparatus may input to the MMFM 200 not only the concatenated data 410 but also prompt input data 420. The prompt input data 420 may correspond to the prompt input data 230 of FIG. 2 as with reference to FIG. 1. The concatenated data 410 may be data in which each piece of image feature data 414 is concatenated/paired with image token data 412 corresponding thereto. A piece of image feature data 414 may correspond to the image feature data 210 of FIG. 2 and a piece of image token data 412 may correspond to the image token data 220 of FIG. 2. An image feature data 414 may be concatenated with an image token data 412 most similar to the image feature data 414 according to the codebook. The data processing apparatus may implicit input information about the relationship between a piece of image feature data 414 and a corresponding piece of image token data 412 to the MMFM 200 by inputting their concatenated data 410 to the MMFM 200. The data processing apparatus may obtain output data reflecting local information of input image data from the MMFM to which the pieces of image feature data 414 the pieces of image token data 412, and implicit information about their relationships are inputted.

FIG. 5 illustrates an example of obtaining output data using an MMFM having at least sequence data as an input, according to one or more embodiments.

Referring to FIG. 5, a data processing apparatus (e.g., the data processing apparatus 600 of FIG. 6) may obtain output data 540 by inputting sequence data to the MMFM 200. The data processing apparatus may generate the input sequence data (to be input to the MMFM 200) using image feature data (e.g., the image feature data 210 of FIG. 2), image token data (e.g., the image token data 220 of FIG. 2), and prompt input data 530. The input sequence data may include image feature sequence data 510 for the image feature data, image token sequence data 520 for the image token data, and the prompt input data 530. The prompt input data 530 may correspond to the prompt input data 230 of FIG. 2 described with reference to FIG. 1.

The input sequence data may include information (e.g., implicitly by its structure, e.g., the order of its elements) about the temporal flow between data forming a sequence and/or information about the order between the data. Since the input sequence data includes the image feature sequence data 510, the input sequence data may include (i) information about the temporal flow between pieces of image feature data forming a sequence and/or (ii) information about the order between pieces of image data. Since the input sequence data includes the image token sequence data 520, the input sequence data may include (i) information about the temporal flow between pieces of image token data and/or (ii) information about the order between image tokens. The image feature sequence data 510 may include starting index data 521 and ending index data 522 (e.g., a start symbol and a terminator symbol). The starting index data 521 may indicate the start of the image feature sequence data 510, and the ending index data 522 may indicate the end of the image feature sequence data 510. The data processing apparatus may input, to the MMFM 200, (i) information about the temporal flow and information about the order between the image feature sequence data 510 and/or (ii) about the image token sequence data 520 by including the starting index data 521 and the ending index data 522 in the image feature sequence input data. The output data 540 outputted by the MMFM 200 may reflect detailed information included in an input image by using (i) the information about the temporal flow and/or (ii) the information about the order included in the input sequence data. The MMFM 200 is described with reference to FIG. 1.

FIG. 6 illustrates an example of a data processing apparatus, according to one or more embodiments.

Referring to FIG. 6, the data processing apparatus 600 may include a memory 610 and a processor 620 (in practice, one or more processors, possibly a combination of varying types of processors).

The memory 610 may store instructions executable by the processor 620. The instructions may be obtained, for example, by compiling source code formed as per the description above. When executed by the processor 620, the instructions may cause the processor 620 to perform a data processing method. The memory 610 may be integrated with the processor 620. For example, random access memory (RAM) or flash memory may be arranged in an integrated circuit microprocessor and the like. In addition, the memory 610 may include a separate device, such as an external disk drive, a storage array, or other storage devices that may be used by a database system. The memory 610 and the processor 620 may be operatively integrated or may communicate with each other via an input/output (I/O) port, a network connection, or the like so that the processor 620 may read a file stored in the memory 610. The memory 610 may be a non-transitory computer-readable storage medium that stores instructions. When executed by the processor 620, the instructions stored in the memory 610 may prompt at least one processor 620 to cause the data processing apparatus 600 to process data.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, a hard disk drive (HDD), a solid state drive (SSD), card memory (e.g., a multimedia card, a secure digital (SD) card, or an extreme digital (XD) card), magnetic tape, a floppy disk, a magneto-optical data storage device, an optical data storage device, a hard disk, a solid state disk, and other devices.

The processor 620 may execute the instructions stored in the memory 610. The processor 620 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof.

When the instructions are executed by the processor 620, the processor 620 may receive input data including input image data and prompt input data to perform a task, obtain image feature data from the input image data using an image encoder, obtain image token data corresponding to the image feature data using an image tokenizer, and obtain output data corresponding to the input data using an MMFM having the prompt input data, the image feature data, and the image token data as an input thereto.

When the instructions are executed by the processor 620, the processor 620 may control the image tokenizer to determine, as the image token data, a code word corresponding to the image feature data among the predefined code words included in a codebook.

When the instructions are executed by the processor 620, the processor 620 may generate input sequence data input to the MMFM using the image feature data, the image token data, and the prompt input data.

When the instructions are executed by the processor 620, the processor 620 may obtain output data by inputting, to the MMFM, data in which the image feature data is concatenated with the image token data corresponding to the image feature data.

FIG. 7 illustrates an example of operations of a training method, according to one or more embodiments.

Operations of the training method may be performed by a training apparatus (e.g., a training apparatus 900 of FIG. 9). In some implementations, the training apparatus may be the same apparatus as the data processing apparatus, and in other implementations the training may be performed by a separate apparatus.

Referring to FIG. 7, in operation 710, the training apparatus may receive training input data, which may include training input image data and training prompt input data to perform a task. The training input data may further include ground truth label data corresponding to the training input image data. The training apparatus may receive the training input date through wired communication, wireless communication, or any combination. The training prompt input data is an instruction or request signal and may be a request signal to perform a task to train a machine learning model.

In operation 720, the training apparatus may obtain training image feature data using an image encoder. The training apparatus may obtain the training image feature data from the training input image data using the image encoder. The image encoder may extract the training image feature data (including a training image feature vector and a training image feature map, for example) from the training input image data. The image encoder may output the training image feature data by preprocessing the training input image data and extracting a feature from the preprocessed training input image data. The preprocessing process may include adjusting the size of the training input image data and normalizing data (e.g., pixel values). The process of extracting a feature may include a process of performing a convolution using a kernel and a pooling process.

In operation 730, the training apparatus may obtain the training image token data using an image tokenizer (e.g., the image tokenizer 300 of FIG. 3). The training apparatus may obtain the training image token data corresponding to the training image feature data using the image tokenizer. The image tokenizer may quantize the training image feature data or compress the training image feature data and then quantize the compressed training image feature data. Quantizing the training image feature data may be mapping the training image feature data to data similar to the training image feature data in a codebook. For example, the training apparatus may control the image tokenizer to map a code word corresponding to the training image feature data among predefined code words included in the codebook to the training image token data, and the data processing apparatus may obtain the training image token data in which the training image feature vector is quantized. The code word corresponding to the training image feature data may be data most similar to the training image feature data in the codebook.

In operation 740, the training apparatus may train an MMFM. The training apparatus may train the MMFM using the training prompt input data, the training image feature data, and the training image token data.

The training apparatus may train the MMFM using supervised learning, unsupervised learning, self-supervised learning, or any combination thereof. However, examples are not limited thereto. The training apparatus may additionally fine-tune the MMFM. The process by which the training apparatus trains the MMFM may include the following training processes. The training process may include (1) data preparation, (2) model initialization, (3) forward calculation, (4) loss calculation, (5) backpropagation, and (6) parameter update. The data preparation process involves the training apparatus collecting and preprocessing training input data. The preprocessing may include cleaning the training input data and, if necessary, performing tasks such as standardization, normalization, and feature selection to prepare the training data to be suitable for use in the MMFM. The preprocessing process may include generating training fusion data based on the training input data. Generating the training fusion data is described below.

The model initialization process sets an initial parameter of the MMFM, which may include, for example, initializing a weight and a bias when the MMFM is a neural network. The forward calculation process includes inputting prepared training input data to the MMFM and calculating an output value of the MMFM. The output value may include output text data, output text token data, output image data, and output token image data corresponding to the training input data. The loss calculation process includes calculating the difference between the output value of the MMFM and an actual ground truth (label) using a loss function. The loss function calculates a value representing how accurate (or inaccurate) the output value of the MMFM is. The backpropagation process includes adjusting parameters of the MMFM to reduce a loss derived through the loss function. By differentiating the value of the loss function through a backpropagation algorithm, the contribution of each parameter of the MMFM to the loss may be calculated, and the parameters of the MMFM may be updated based on the calculated value. The parameter update process includes updating the parameters of the MMFM using a calculated gradient. A gradient descent scheme or variants of the gradient descent scheme may be used in the usual manner for the parameter update process. Through this process, the MMFM may be trained to output increasingly accurate output values. The above processes (forward calculation, loss calculation, backpropagation, and parameter update) may be repeated multiple times for a large number of training data, and training may proceed multiple times until the MMFM is sufficiently trained.

The training apparatus may train the MMFM by simultaneously using the training image feature data and the training image token data. The training apparatus may generate the training fusion data using pieces of training data and pieces of training token data extracted from the pieces of training data. The training fusion data may include the training input sequence data using the training image feature data and the training image token data or training data in which the training image feature data is concatenated with the training image token data. The training apparatus may more deeply train, into the MMFM, the correlation between pieces of training data and train detailed information of the training input image data by training the MMFM using the training fusion data. The training apparatus may improve the performance of the MMFM while ensuring robustness by training the MMFM using the training fusion data.

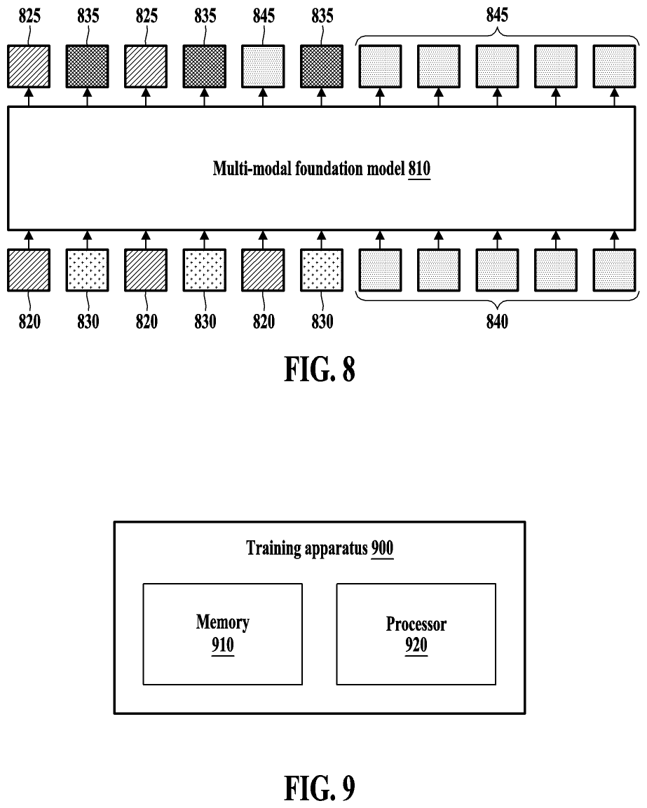

FIG. 8 illustrates an example in which a training apparatus trains an MMFM based on masked output image feature data, according to one or more embodiments. A training apparatus (e.g., the training apparatus 900 of FIG. 9) may use output image feature data during the process of training an MMFM or may exclude some of the output image feature data by masking the output image feature data.

Referring to FIG. 8, the training apparatus may input, to an MMFM 810, training prompt input data 840, training image feature data 830, and training image token data 820. The training apparatus may input, to the MMFM 810, training sequence data generated using the training prompt input data 840, the training image feature data 830, and the training image token data 820. The MMFM 810 may correspond to the MMFM 200 of FIG. 2.

The training apparatus may obtain, from the MMFM 810, output image token data 825, output image feature data, and output text token data 845. The training apparatus may train the MMFM 810 using the training prompt input data 840, the training image feature data 830, the training image token data 820, the output image token data 825, the output image feature data, and the output text token data 845. The training apparatus may train the MMFM 200 using the training image feature data 830 and the output image feature data so that detailed information of the training input image data is reflected in an output of the MMFM 200.

The training apparatus may mask the output image feature data and train the MMFM 810 using the training prompt input data 840, the training image feature data 830, the training image token data 820, the output image token data 825, and the output text token data 845. The training apparatus may train the MMFM 810 to have the same effect (e.g., improve the robustness of the MMFM 810) as training the MMFM 810 using only the training image token data 820 and the training prompt input data 840 without using the masked output image feature data 835.

FIG. 9 illustrates an example of a training apparatus, according to one or more embodiments.

Referring to FIG. 9, the training apparatus 900 may include a memory and a processor.

A memory 910 may store instructions executable by a processor 920. When executed by the processor 920, the instructions executable by the processor 920 may cause the processor 920 to perform a training method. The memory 910 may be integrated with the processor 920. For example, RAM or flash memory may be arranged in an integrated circuit microprocessor and the like. In addition, the memory 910 may include a separate device, such as an external disk drive, a storage array, or other storage devices that may be used by a database system. The memory 910 and the processor 920 may be operatively integrated or may communicate with each other through an I/O port or a network connection so that the processor 920 may read a file stored in the memory 910. The memory 910 may be a non-transitory computer-readable storage medium that stores instructions. When executed by the processor 920, the instructions stored in the memory 910 may prompt at least one processor 920 to cause the training apparatus 900 to process data.

Examples of a non-transitory computer-readable storage medium may include ROM, PROM, EEPROM, RAM, DRAM, SRAM, flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY, or optical disk memory, an HDD, an SSD, card memory (e.g., a multimedia card, an SD card, or an XD card), magnetic tape, a floppy disk, a magneto-optical data storage device, an optical data storage device, a hard disk, a solid state disk, and any other devices.

When the instructions are executed by the processor 920, the processor 920 may receive training input data including training input image data and training prompt input data to perform a task, obtain training image feature data from the training input image data using an image encoder, obtain training image token data corresponding to the training image feature data using an image tokenizer, and train an MMFM using the training prompt input data, the training image feature data, and the training image token data.

When the instructions are executed by the processor 920, the processor 920 may obtain, from the MMFM, output image token data, output image feature data, and output text token data and train the MMFM using the prompt input data, the training image feature data, the training image token data, the output image token data, and the output text token.

The computing apparatuses, the electronic devices/apparatuses, the processors, the memories, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described herein are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A data processing apparatus comprising:
one or more processors; and
a memory storing instructions configured to cause the one or more processors to:
receive input data comprising input image data and prompt input data to perform a task;
obtain image feature data from the input image data using an image encoder;
obtain image token data corresponding to the image feature data using an image tokenizer; and
input, as input data, to a multi-modal foundation model (MMFM), the prompt input data, the image feature data, and the image token data, wherein the MMFM infers output data therefrom.

2. The data processing apparatus of claim 1, wherein the instructions are further configured to cause the one or more processors to control the image tokenizer to determine, as the image token data, a code word corresponding to the image feature data among predefined code words comprised in a codebook.

3. The data processing apparatus of claim 2, wherein the code book comprises associations between the predefined code words and predefined pieces of image feature data.

4. The data processing apparatus of claim 3, wherein the instructions are further configured to cause the one or more processors to select the code word by finding one of the pieces of image feature data in the code book that is determined to be similar to the image feature data.

5. The data processing apparatus of claim 1, wherein the instructions are further configured to cause the one or more processors to generate input sequence data to be input to the MMFM using the image feature data, the image token data, and the prompt input data.

6. The data processing apparatus of claim 1, wherein, when the instructions are further configured to cause the one or more processors to infer the output data by inputting, to the MMFM, data in which the image feature data is concatenated with the image token data, which corresponds to the image feature data.

7. The data processing apparatus of claim 1, wherein
the image feature data is a sequence of image features, and
the sequence of image features comprises a starting index indicating a start of the sequence of image features and an ending index indicating an end of the sequence of image features.

8. The data processing apparatus of claim 1, wherein the MMFM is a multi-modal large language model (MMLLM).

9. The data processing apparatus of claim 1, wherein the prompt input data comprises text data or text token data obtained from of audio input data or text input data.

10. A training apparatus for training a multi-modal foundation model (MMFM), the training apparatus comprising:
one or more processors; and
a memory storing instructions configured to cause the one or more processors to:
receive training input data comprising training input image data and training prompt input data to perform a task;
obtain training image feature data from the training input image data using an image encoder;
obtain training image token data corresponding to the training image feature data using an image tokenizer; and
train the MMFM using the training prompt input data, the training image feature data, and the training image token data.

11. The training apparatus of claim 10, wherein, when the instructions are further configured to cause the one or more processors to:
obtain, from the MMFM, output image token data, output image feature data, and output text token data; and
train the MMFM using the prompt input data, the training image feature data, the training image token data, the output image token data, and the output text token.

12. A data processing method comprising:
receiving input data comprising input image data and prompt input data to perform a task;
obtaining image feature data from the input image data using an image encoder;
obtaining image token data corresponding to the image feature data using an image tokenizer; and
inputting, as input data, to a multi-modal foundation model (MMFM), the prompt input data, the image feature data, and the image token data, wherein the MMFM infers an output therefrom.

13. The data processing method of claim 12, wherein the obtaining of the image token data comprises controlling the image tokenizer to determine, as the image token data, a code word corresponding to the image feature data among predefined code words comprised in a codebook.

14. The data processing method of claim 12, further comprising:
generating input sequence data to be input to the MMFM using the image feature data, the image token data, and the prompt input data.

15. The data processing method of claim 12, wherein the inferring of the output data comprises obtaining the output data by inputting, to the MMFM, data in which the image feature data is concatenated with the image token data corresponding to the image feature data.

16. The data processing method of claim 12, wherein
the image feature data is a sequence of image features, and
the sequence of image features comprises a starting index indicating a start of the sequence of image features and an ending index indicating an end of the sequence of image features.

17. The data processing method of claim 12, wherein the MMFM is a multi-modal large language model (MMLLM).

18. The data processing method of claim 12, wherein the prompt input data comprises text data or text token data obtained from audio input data or text input data.
